(19) United States
(12) Patent Application Publication
(10) Pub. No.: US 2009/0164186 A1
(43) Pub. Date: Jun. 25, 2009

(54) Method for determining improved estimates of properties of a model

(75) Inventors: Mark C. Haase, Katy, TX (US); Michael Edwin Glinsky, Houston, TX (US); James Gunning, Brunswick East (AU)

Correspondence Address: KOPPEL, PATRICK, HEYBL & DAWSON, 2815 Townsgate Road, SUITE 215, Westlake Village, CA, 91361-5827, US

(73) Assignee: BHP BILLITON INNOVATION PTY LTD.

(21) Appl. No.: 12/004,651

(22) Filed: Dec. 20, 2007

(51) Int. Cl. G06F 7/60; G06G 7/48

(52) U.S. Cl. 703/10; 703/2

(57) ABSTRACT

A method is disclosed for determining improved estimates of properties of a model, on the basis of estimated prior constraints, by running a mathematical inversion several times using the output posterior estimate of the previous inversion, or any of the previous inversions to provide an input for the next inversion. This iterative inversion may be repeated until the prior and posterior estimates converge to within a given threshold. The method may be applied to seismic data, using a seismic inversion, in order to improve the prediction of the viability of potential petroleum reservoirs by determining improved estimates of volumetric properties of a subsurface region.

The present invention relates to the general area of the analysis and interpretation of measured data, in particular the analysis of subsurface regions on the basis of seismic data, and more particularly to the processing of seismic inversion data to estimate the probability of an economic volume of hydrocarbons being present in a field under evaluation. In more detail, a method is disclosed for improving prediction of modelled physical properties, and in particular for improving prediction of the viability of potential petroleum reservoirs by determining improved estimates of volumetric properties of a subsurface region.

### BACKGROUND OF THE INVENTION

In the appraisal of oil or gas fields, there often arises the business decision of whether or not to develop a sand which is at the limit of seismic resolution and near the noise level of the data. The critical issue is developing a reasonable certainty that there is enough volume of hydrocarbons to develop. A popular approach is to use Bayesian methods to determine the probability of an economic volume of hydrocarbons being present. A problem with this approach when it is applied for the marginal cases that we have described is a bias to the answer. Often, this comes from a relatively strong sophomoric prior constraint on the gross thickness and net-to-gross (N/G) of the sands, imposed to keep the inversion focused on the correct seismic reflector. The data is whispering what the answer should be through the Bayesian apparatus, but this whisper is overwhelmed by the sophomoric prior constraints. It is therefore desirable to be able to utilize such Bayesian methods, but without the result being unduly influenced by the prior constraints.

There has been much recent interest and application of Bayesian seismic inversion. The main attractiveness of these methods from a business perspective is the fact that they give an estimate of the uncertainty in the estimate of the volumetrics of potential oil and gas fields. Many times, this is the main contributing factor to economic uncertainty, and therefore can be the deciding factor in business decisions.

A classic such decision is whether or not to proceed with construction of a liquefied natural gas (LNG) facility. There must be a high degree of confidence that the field will supply enough gas to deliver on the contracts and be economic. This is translated into the uncertainty estimation challenge to have the probability of having the contracted volume to be 90% or greater (i.e., contracted volume less than P90 volume). Often, the outstanding challenge is that the gross thickness of the sands is thin enough that the magnitude of the reflection is not a lot larger than the seismic noise level. In this situation, Bayesian seismic inversion is helpful in determining the critical uncertainty. That is, advanced technology is used when the answer is not obvious.

The influence of the choice of the prior in these subtle cases can be a problem. The actual value is within a standard deviation or two of the contracted amount so that if the prior is set greater than the actual value by an amount of order the posterior standard deviation or more, the posterior estimate of the median and the P90 volume will be biased high by about a standard deviation. This will cause the field to look safely economic, when it is not. The opposite is true if the prior is set less than the actual value. There will appear to be significant risk that the field is not economic, when it is probably economic. The decision should not rest on the prior estimate of the volumes.

It would therefore be desirable to provide a purely data driven way to determine the median and P90, which is not significantly influenced by the prior assumptions. As well as estimating the probability of having an economic volume, it is also desirable in certain cases to know the probability distribution (sometimes the mean, standard deviation, P90, P10 and P50, i.e. median, values) of many different properties as a function of layer and position, as well as integrals of those properties (which may be, for example, net sand, thickness, N/G or sand porosity) over position (an example is the total volume of sand). Many of these estimates relate to volumetric properties, but they are not limited to volume estimation.

The same problem can also apply in many other applications for which a mathematical inversion such as a Bayesian inversion is used to estimate the values or probability distributions of properties on the basis of prior estimates or measured data.

### SUMMARY OF THE INVENTION

A new and improved method is disclosed for determining improved estimates of properties of a model, on the basis of estimated prior constraints which may be based on measured data. The method provides for the use of a mathematical inversion, such as a Bayesian inversion, in a way in which the prior constraints do not unduly influence the output data, and in which estimates of modelled properties are therefore provided which exhibit improved accuracy and reduced uncertainty.

In a particular example, a new and improved method is disclosed for improving prediction of the viability of potential petroleum reservoirs by determining improved estimates of volumetric properties of a subsurface region, on the basis of seismic data.

More specifically, the method comprises the steps of:
(a) receiving estimated prior constraints for at least one model property,
(b) performing a first mathematical inversion on data for the model, using the estimated prior constraints, to produce an output posterior estimate of the at least one property,
(c) repeating the seismic inversion at least once, using the output posterior estimate of the previous inversion, or of any of the previous inversions, to provide an input constraint for each successive inversion, to produce an improved posterior estimate of the at least one property.

It should be noted that, in step (c), the output posterior estimate may itself be used as an input constraint for the successive inversion, or may be used as the basis for such a constraint. For example, the output posterior estimate may be modified or combined with the output posterior estimates from other previous inversions.

In step (a), the estimated prior constraints may include a central value and associated range information for the property, and in step (c), the output central value of the previous inversion may then be used as the input central value for each successive inversion. The central value may for example be a mean, median or most likely value, and the range information may comprise any information about the probability of the property taking particular values either side of the central value, such as a standard deviation.

The mathematical inversion may be a seismic inversion carried out on seismic data, such that the model relates to properties of a subsurface region.

The method may be implemented as a computer program, which can be executed on one or more computers, and may be executed by a plurality of computers interconnected via a wired or wireless communication medium.

In accordance with this method when applied to seismic data, the inventors found that by running the seismic inversion several times using the output mean of the previous inversion as the input mean of the next inversion, this methodology made the difference, in conjunction with a bandwidth improvement in the seismic data, in making the decision that a well should be drilled.

In one embodiment, the method comprises taking the mean output of a Bayesian inversion and using that as the mean of the input for a second Bayesian inversion, but without changing the prior standard deviation. This process may then be repeated until there is not much change going from the prior to the posterior mean. This repetition of this iterative process may be carried out a predetermined number of times, selected to ensure a reasonable convergence, or may be carried out until it is determined that the difference between the prior and posterior mean for a given iteration is smaller than a predetermined threshold.

Through this iterative process the Bayesian inversion is effectively whispering whether the answer is high or low, allowing the bias to be removed. It has been found by the inventors that this method achieves the surprising outcome that the estimate of the mean is biased to much less than a standard deviation.

In the analysis of seismic data, another factor that is well known to help resolve the uncertainty of net sand thickness for thin sands, is to increase the bandwidth (effective resolution) of the seismic data. In a sand that is at or below the resolution of the seismic data, the net sand can be determined, provided that the sand is acoustically softer than the surrounding shale. Unfortunately the gross thickness and N/G are not able to be estimated. Once the bandwidth has been increased enough, both the gross thickness and N/G can be resolved. This may not solve the problem of the bias if the reflection strength of the resolved sand is not large enough or the noise is too large to see the seismic reflector. The iterative process, in this case, will still be needed to remove the bias in the estimate of the gross thickness, net thickness, and N/G, not only the net thickness of the previous unresolved case. Nevertheless, it is most beneficial if the bandwidth (defined as the maximum to the minimum frequency for which the signal exceeds the noise) is high enough to resolve geologic layers.

In the following description, it is shown that this iterative process is theoretically convergent and works for a wedge model. The method is demonstrated on a small target called Glenridding under the main pay sand of the Stybarrow field, offshore Western Australia. The effect of increased resolution of the seismic data for this case is also shown. Use of this technology along with improved seismic data will show an accumulation that is probably economic.

### BRIEF DESCRIPTION OF THE DRAWINGS

The patent or application file contains at least one drawing executed in color. Copies of this patent or patent application publication with color drawings will be provided by the Office upon request and payment of the necessary fee.

Further embodiments, advantages, features and details of the present invention will be set out in the following description with reference to the drawings, in which:

FIG. 1(a) shows different prior probability distributions for gross thickness, and FIG. 1(b) shows corresponding posterior probability distributions;

FIG. 2 shows schematically the iterative Bayesian inversion process according to the described method;

FIG. 3 shows a wedge model and synthetic seismic;

FIG. 4 shows the results of iteration of inversion on the wedge model;

FIG. 5 is a map showing the location of the Stybarrow field;

FIG. 6 is a map of the Stybarrow field with depth contours. The locations of the four appraisal wells are shown. The cross section location, shown in FIG. 7, is indicated by the red line.

FIG. 7(a) is a cross section of the Stybarrow field, along the line 60 shown in FIG. 6, showing seismic reflection data and using the old data, and FIG. 7(b) is a corresponding cross section using the new, higher bandwidth, data;

FIG. 8 shows the spectral signal to noise ratio determined by comparison to the well log synthetic seismic, for the old and new data;

FIG. 9 shows mean models of N/G and seismic reflection data for the Glendenning target, for: (a) the initial model, before inversion, using the old data; (b) the model after inversion using the old data; and (c) the model after inversion using the new data;

FIG. 10 shows a summary of the different estimates of net sand;

FIG. 11(a) shows a comparison of the synthetic seismic to the actual seismic, for the initial model, before inversion, using the old data, FIG. 11(b) shows a corresponding comparison for the model after inversion using the old data, and FIG. 11(c) shows a corresponding comparison for the model after inversion using the new data;

FIG. 12 shows an ensemble of N/G models, for: (a) the initial model, before inversion, using the old data; (b) the model after inversion using the old data; and (c) the model after inversion using the new data;

FIG. 13 shows the effect of the prior gross sand thickness on the mean net sand;

FIG. 14 shows the effect of the prior N/G on the output N/G from the inversion; and

FIG. 15(a) shows the cumulative probability distribution of net sand using the old seismic data, and FIG. 15(b) shows the corresponding cumulative probability distribution using the new seismic data.

### DETAILED DESCRIPTION

A general description of the problem will first be presented, together with a sketch of the underlying theory, outlining the starting assumptions, but passing quickly to the practical conclusions of the theory.

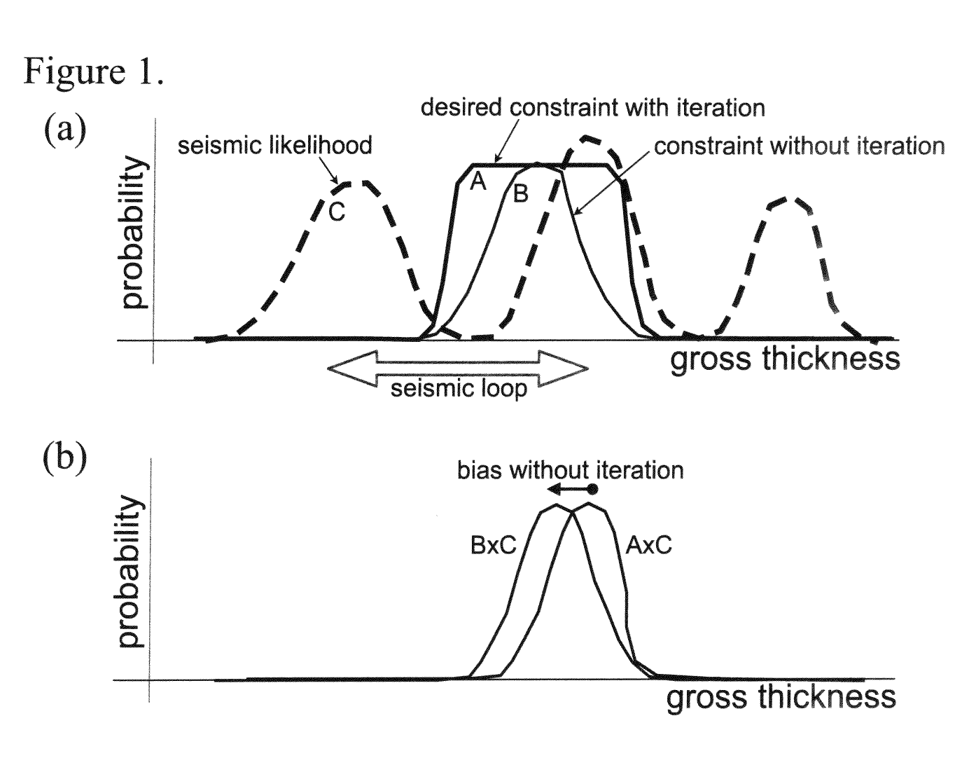

The work of the inventors is based on the Bayesian model-based seismic inversion program, Delivery, developed by the inventors (Gunning and Glinsky, 2004). Markov Chain Monte Carlo (MCMC) and/or Metropolis methods may also be used. In this layer-based model, a useful prior constraint that makes the inversion problem less multimodal is to focus the inversion on the correct seismic reflection for each sand or shale layer. This is done by imposing Gaussian prior distributions on the layer reflection times, gross thicknesses, and N/G values. These constraints are made as weak as possible, but strong enough to prevent a seismic “loop skip”, or trapping in undesirable secondary local minima. This “lion taming” of the objective function is demonstrated by FIGS. 1(a) and 1(b), which show the effect of the prior constraint on the bias of the posterior distribution. FIG. 1(a) shows different prior probability distributions, and FIG. 1(b) shows resulting posterior probability distributions. In FIG. 1(a), curve C shows the probability of the model seismic being consistent with the observed seismic as a function of the gross thickness of the sand. The side lobes correspond to the sand becoming thick enough that the reflector would correspond to the top of another sand. The solutions that correspond to these sidelobes are not reasonable solutions and need to be excluded. This is done by imposing the Gaussian constraint on gross thickness, shown by curve B. Unfortunately the resulting compound probability, shown as B×C in FIG. 1(b), has a maximum biased away from the desired local maximum of curve C. What we would like to do is impose a prior constraint similar to curve A (FIG. 1(a)) with a flat top. This type of nonlinear prior constraint is not used, however since it breaks the linearity of the inversion, and seriously inflates the numerical demands of the inversion.

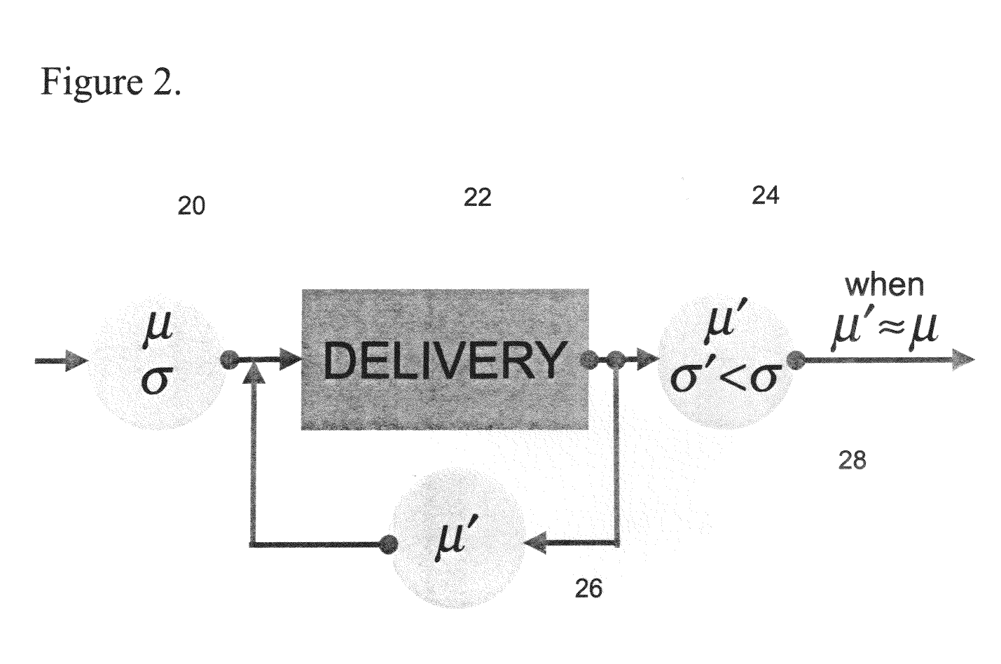

To harness both the computational advantages of the Gaussian prior (curve B), and the unbiased character of curve A, the inventors implemented an iterative inversion. This iterative inversion is shown schematically in FIG. 2. We start with the normal Gaussian constraint on reflection times, gross thicknesses, and N/G and do the Bayesian inversion. It should be noted that the input constraints may relate to any relevant properties, for example seismic arrival times, layer thicknesses, net sand to gross sand ratio, sand porosity, or other sand and shale properties such as compressional velocities, shear velocities and density. The properties being iterated are illustrated in step 20, where μ is the mean of a property being iterated and σ is the standard deviation In step 22, the inversion is carried out, for example using the Delivery tool mentioned above, to produce the posterior estimates shown in step 24, where μ′ is the posterior mean and σ′ is the posterior standard deviation. The resulting posterior estimates of the mean times, gross thicknesses, and N/G are then used (step 26) as the mean of the prior constraints for the next Bayesian inversion. In other words, step 22 is repeated using the modified means, but the standard deviations used in the inversion remain unchanged. This process is then repeated, and stopped when there is little difference between the prior and posterior means of the three properties (step 28). The prior and posterior means may be compared after each inversion to determine whether the difference between the prior and posterior means is within a predetermined threshold, and the process stopped when this is found to be the case.

In order for this process to work the mapping of the prior to the posterior means must be a compact mapping whose fixed point has an effective constraint which will not bias the solution, as shown by curve A in FIG. 1(a). By linearizing the solution about the optimum point (see Appendix), and by separating the prior constraint into the parts that will be iteratively updated and those which will not; it can be proved that a fixed point exists and that the convergence is linear. The fixed point is the solution to the problem with the prior Gaussian constraints removed on the updated parts. This is exactly what is needed. A condition on the convergence is that the linearized problem is not rank deficient, that is, it is well posed. This will be true as long as the sensitivity matrix for all the parameters being iterated is “full rank”. This means that care should be taken in the choice of the properties that are iterated—the inversion should be significantly decreasing the standard deviations of those properties and they should not be linearly dependent upon each other.

### Simple Wedge Model

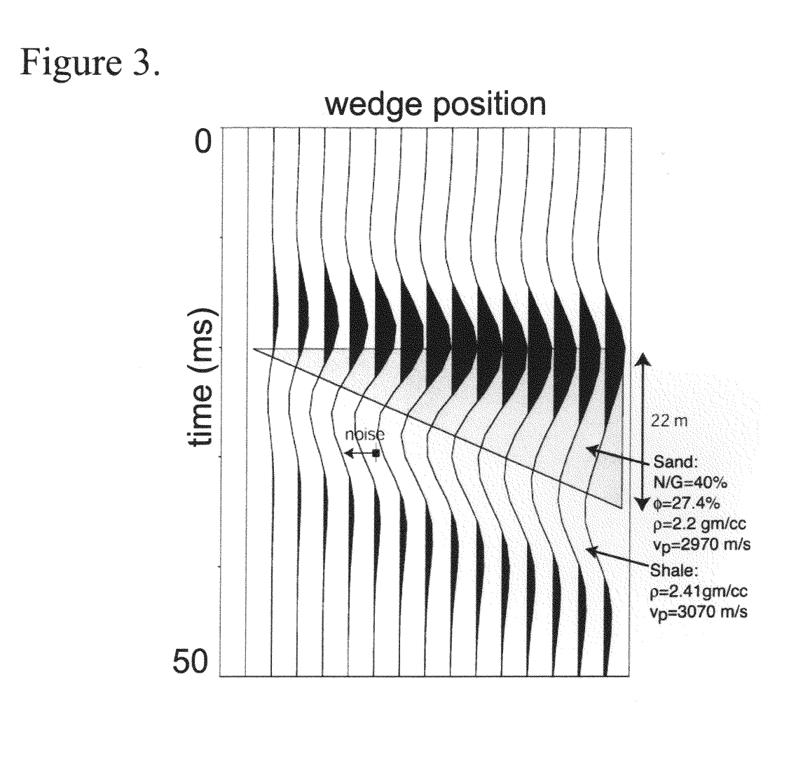

To demonstrate and verify the unbiased result of the described iterative inversion, a simple wedge model was constructed. It consists of three layers: a laminated reservoir sand between two shales. FIG. 3 shows the wedge model and the synthetic seismic. The wiggle trace is reflection coefficient data with a positive amplitude, shaded black, representing a reflection from a hard reflector over a soft reflector. The wedge starts at zero gross thickness and linearly increases to a thickness of 22 m. The sand is softer than the shale, and has a N/G of 40%. The end member sand has a porosity of 27.4%, a density of 2.2 gm/cc, and a compressional velocity of 2970 m/s. The shale has a density of 2.41 gm/cc, and a compressional velocity of 3070 m/s. Convolving a Ricker wavelet with the contrast in the acoustic impedance forms the synthetic seismic. The frequency of the wavelet was chosen to have a tuning thickness of 14 m. The N/G standard deviation for the reservoir layer was 0.2. Uncertainties for the end member properties were 87 m/s, 142 m/s and 1.7% for the sand compressional velocity, shear velocity and porosity, respectively; and 138 m/s, 70 m/s, and 0.035 gm/cc for the shale compressional velocity, shear velocity and density, respectively. Time uncertainties of 10 ms were assumed for the two seismic reflectors.

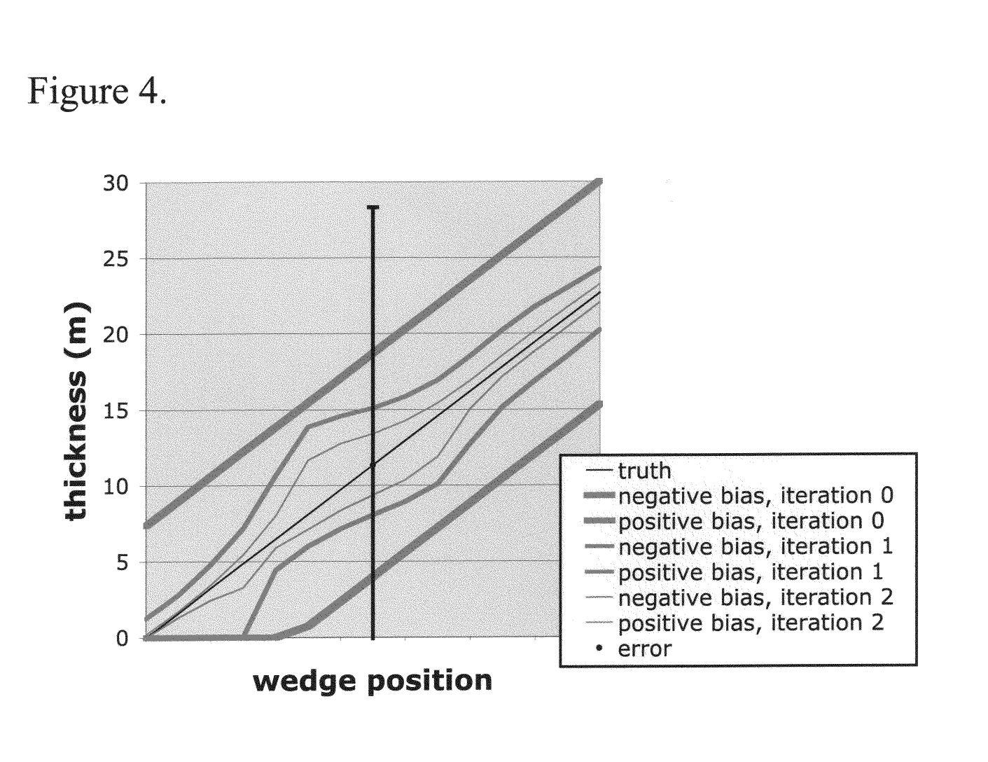

Two series of inversions were done: the first starting with a model that always had 5 m more sand than the model used to construct the seismic, the second starting with a model that always had 5 m less sand. A noise level of about half the size of the reflector was assumed. The gross thickness was iterated for each series of inversions until the solution converged. The result is shown in FIG. 4, in which the case starting with a positive bias of 5 m is shown by the green curves, and the case starting with a negative bias of 5 m is shown by the red curves. The initial model and two iterations are shown for each case, and a representative standard deviation of the solutions is shown by the error bar. The answer and fixed point solution is shown as the thin black line. The posterior uncertainty in the gross thickness was about three times the size of the initial bias. The solutions obviously converged to the unbiased solution. It was noted that the convergence was made quite rapid (within one to two iterations) for noise level merely 50% of that displayed in FIG. 3.

### FIELD EXAMPLE

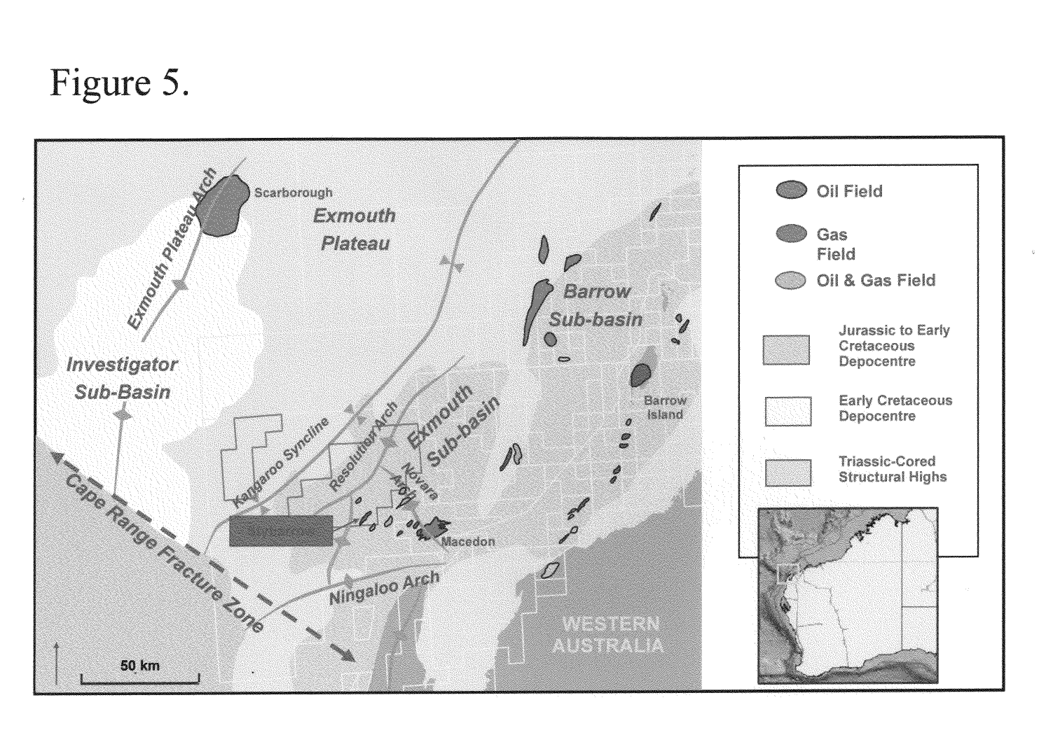

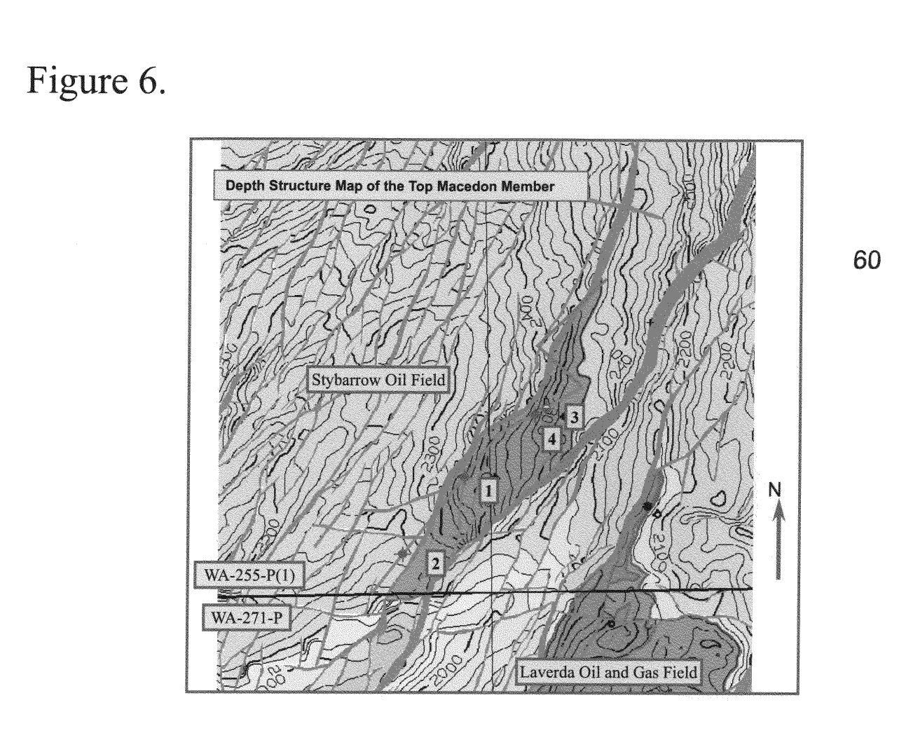

The methodology was then applied to the Glenridding prospect, which lies beneath the Stybarrow Field, influencing the business decision to drill. This Stybarrow field is located in Production License WA-32-L, some 135 km west of Onslow offshore Western Australia. The water depth at the location is approximately 800 m. The field lies near the southern margin of the Exmouth sub-basin within the larger Carnarvon Basin (see FIG. 5). Oil is trapped in the Early Cretaceous, Berriasian age turbidite and debris flow sandstones deposited on a relatively shallow passive margin slope. The Stybarrow structure comprises a NE to SW trending tilted fault block forming a terrace within the westward plunging Ningaloo Arch (see FIG. 6, which also shows the locations of the four appraisal wells). The intersection of SW to NE and E to W trending normal faults establishes an elongate, triangular trap forming structural closure to the southwest. The structure dips from the SW to the NE at about 5 degrees. Top, base and bounding fault seals are provided by claystones and siltstones of the overlying Muiron Member of the Barrow Group and mudstones of the underlying Dupuy Formation.

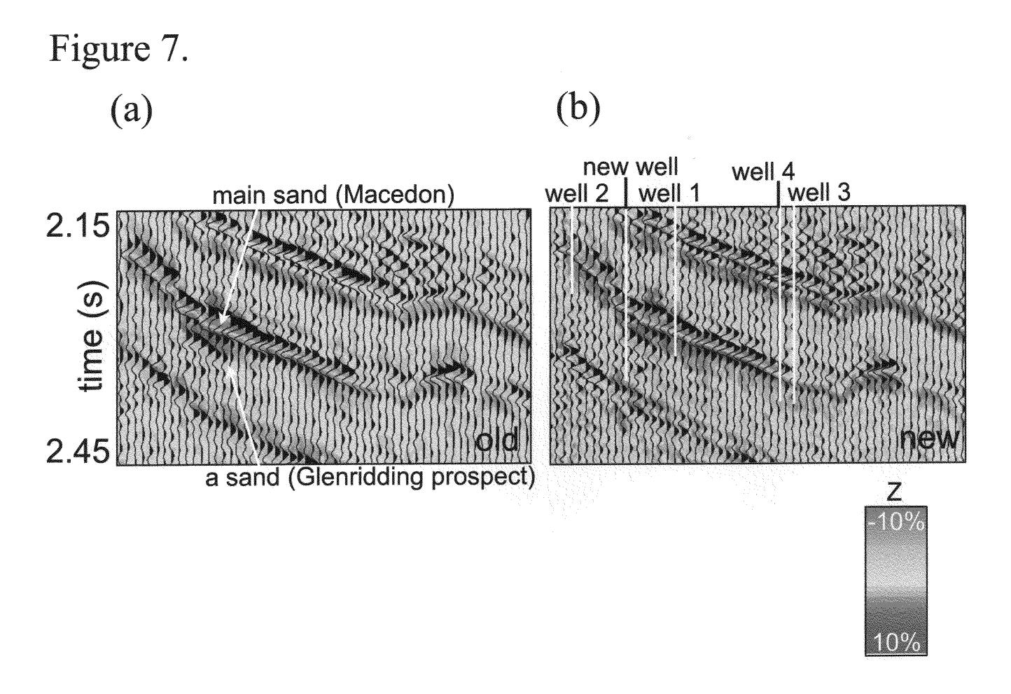

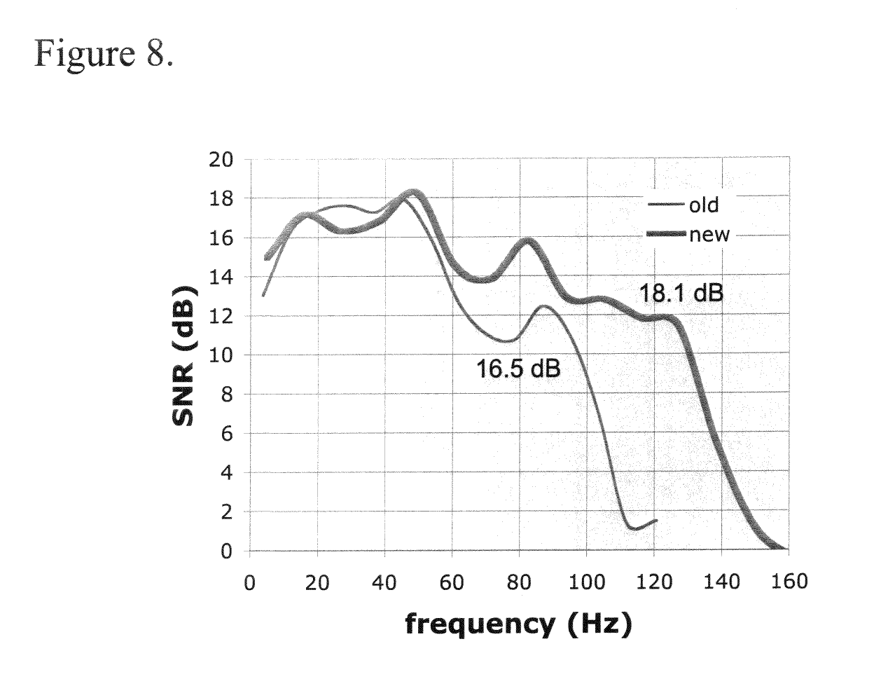

A seismic dip cross section through the middle of this field, along the line 60 in FIG. 6, is shown in FIGS. 7(a) and 7(b). Seismic reflection data is shown as black wiggles. A positive amplitude is shaded black and represents a reflection from an acoustically hard rock over a soft. The colored background is a sparse spike inversion. Values are normalized and expressed in relative percent reflectivity. Red is acoustically soft, blue is hard. Note the main sand that is currently under development (the Macedon Standstone) and the location of the four appraisal wells. The seismic data was recently reprocessed in a way that increased the bandwidth, and FIG. 7(a) shows the old data, while FIG. 7(b) shows the new, higher bandwidth, data. FIG. 8 shows the spectral signal to noise ratio determined by comparison to the well log synthetic seismic. The signal is the peak amplitude of the main sand reflector, and the posted signal to noise ratios are the peak reflection amplitude of the main sand divided by the noise level estimated by the stochastic wavelet derivation (Gunning and Glinsky, 2006).

This reprocessing highlighted a small, but possibly economic “a sand” called the Glenridding prospect, that has not yet been penetrated, approximately 50 m below the main Macedon sand (see FIG. 7(a)). Given the limited aerial extent of this near field prospect, it would need to have a thickness of at least 4 m to economically breakeven. In order to drill this target, it needs to be proven that there is a 90% probability of having at least 4 m of sand.

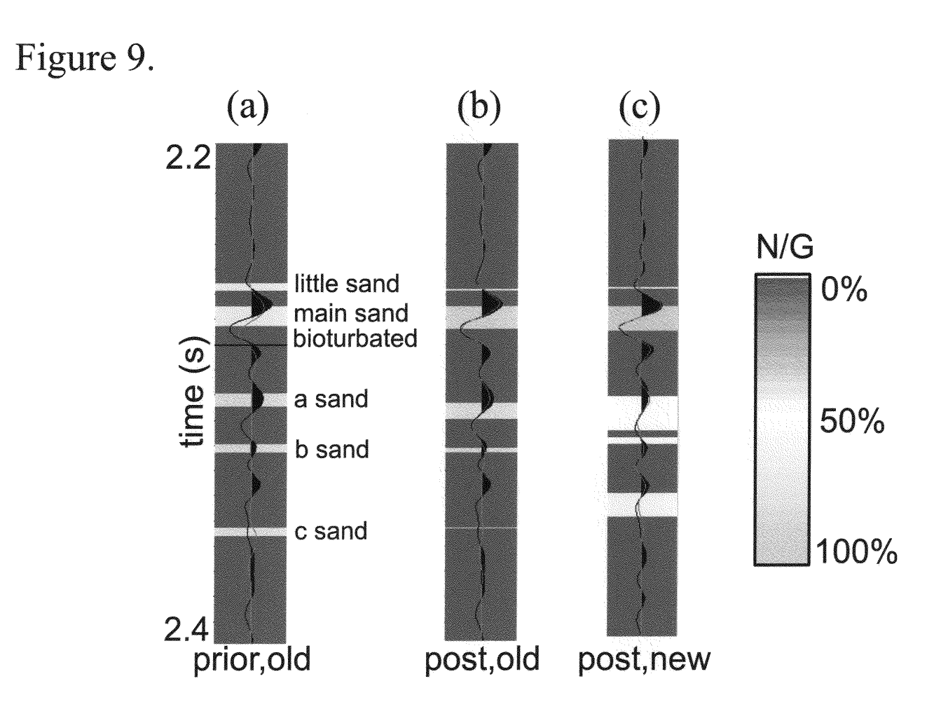

To answer this question a Bayesian model based inversion was done at the proposed well location shown in FIG. 7(b). A model was constructed as shown in FIG. 9(a), which shows the mean model of N/G, before inversion, using the old data. The black wiggle shaded black is the seismic reflection data, and the red wiggle is the synthetic seismic of an average model (as determined by the seismic chi squared value). The model has twelve layers, five of which are sands. It was built from an interpretation of the top and base of the main (Macedon) sand, and the top of the Glenridding “a sand”. Small uncertainty was assumed for the position of these interpreted horizons (6 ms), and a larger uncertainty for the other horizons (8 ms). The uncertainty in the N/G was assumed to be 30% with a initial mean of 85% for all sands. More details on how this inversion was done can be found in Glinsky et al. 2005.

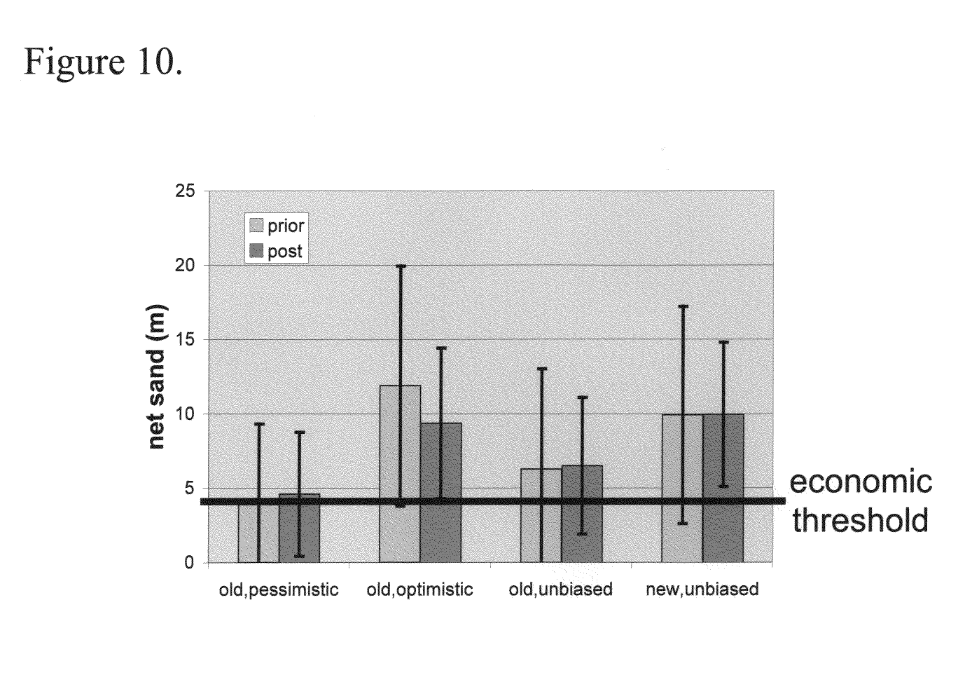

The first inversion was done using the old data. The seismic specialists doing the inversion decided to make a pessimistic assumption for the initial thickness of the “a sand”—they assumed that it had zero thickness and had the inversion prove otherwise. Because the noise level was about the size of the seismic reflection this was a reasonable possibility. The resulting estimate of the net sand shown in FIG. 10 does not meet the criteria for drilling the well. The asset team members challenged this result suggesting an optimistic assumption that there is a sand of tuning thickness unless proven otherwise. This was also a reasonable possibility. The resulting estimate also shown in FIG. 10 does meet the criteria for drilling the well. Who was right? Finding the answer to this question was the inspiration for the inventors' development of the iterative inversion. The unbiased answer from the iterative inversion using both the old and the new data is shown in FIG. 10.

The results shown in FIG. 10 represent the different estimates of net sand for the “a sand”, with the error bars representing the standard deviation. The “old, pessimistic” case is using the old data with an initial N/G of 85% and an initial gross thickness of 3 m. The “old, optimistic” case is using the old data with an initial N/G of 85% and an initial gross thickness of 16 m. The “old, unbiased” case is using the old data with an initial N/G of 85% and an initial gross thickness of 8 m, using the iterative inversion, and the “new, unbiased” case is for the iterative inversion using the new data with an initial N/G of 50% and an initial gross thickness of 22 m.

The unbiased solution using the old data is obviously a compromise between the optimistic and pessimistic solutions and unfortunately does not meet the criteria for drilling the well. Fortunately the resolution provided by the new data increases the estimate of the net sand enough to meet the criteria for drilling the well. Note that the new, unbiased result is consistent with the old, unbiased result (i.e., the new mean lies within the uncertainty of the old data), but it is not consistent with the old, pessimistic result.

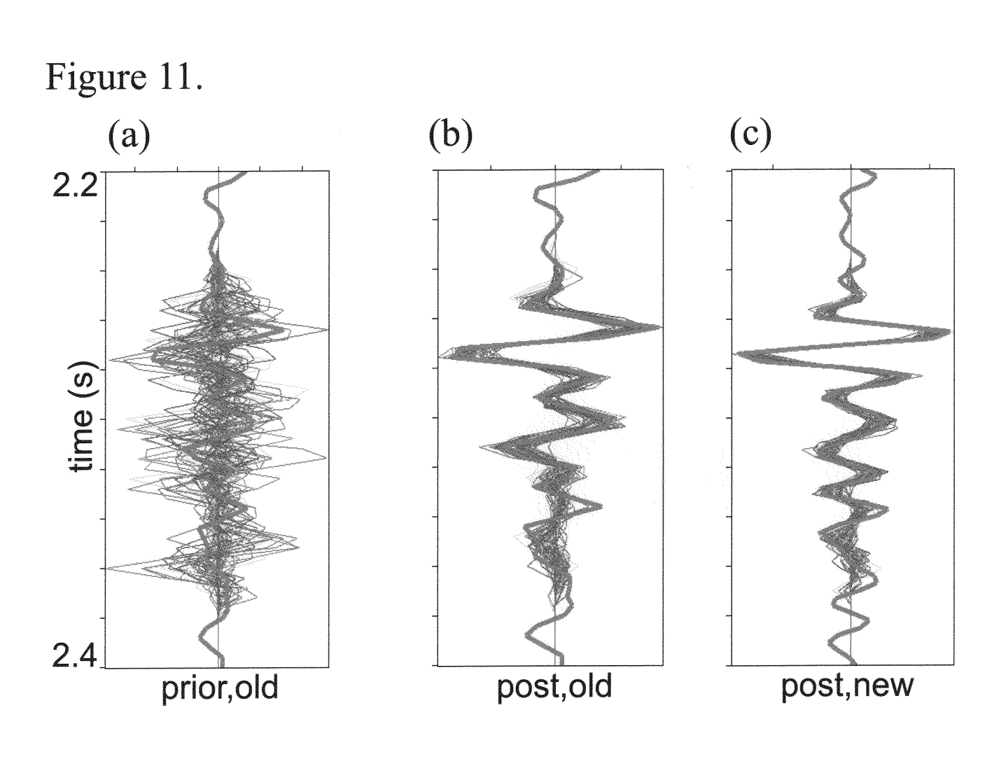

Let us now examine the results in more detail so that we can better understand them. Start with the mean models shown in FIG. 9. FIGS. 9(b) and 9(c) show the models of N/G after inversion. FIG. 9(b) shows the results using the old data, where the initial N/G was 85%, and initial gross thickness was 8 m. FIG. 9(c) shows the results using the new data, where the initial N/G was 50%, and initial gross thickness was 22 m Both the inversions using the old and the new data increase the N/G and gross thickness of the main sand. There is no change to the N/G of the “a sand” using the old data and a very modest increase to the net sand. This is because this sand is not resolved. The new data is able to resolve this sand. It dramatically increases the thickness, but significantly decreases the N/G with an increase in the net sand. It also increases the N/G of the main sand. FIG. 11 shows the match of the model synthetic seismic to the actual seismic (thick red line) for the initial model, before inversion, using the old data (FIG. 11(a)), the model after inversion, using the old data (FIG. 11(b)), and the model after inversion, using the new data (FIG. 11(c)) Note the better match using the new data due to the better signal to noise ratio (SNR).

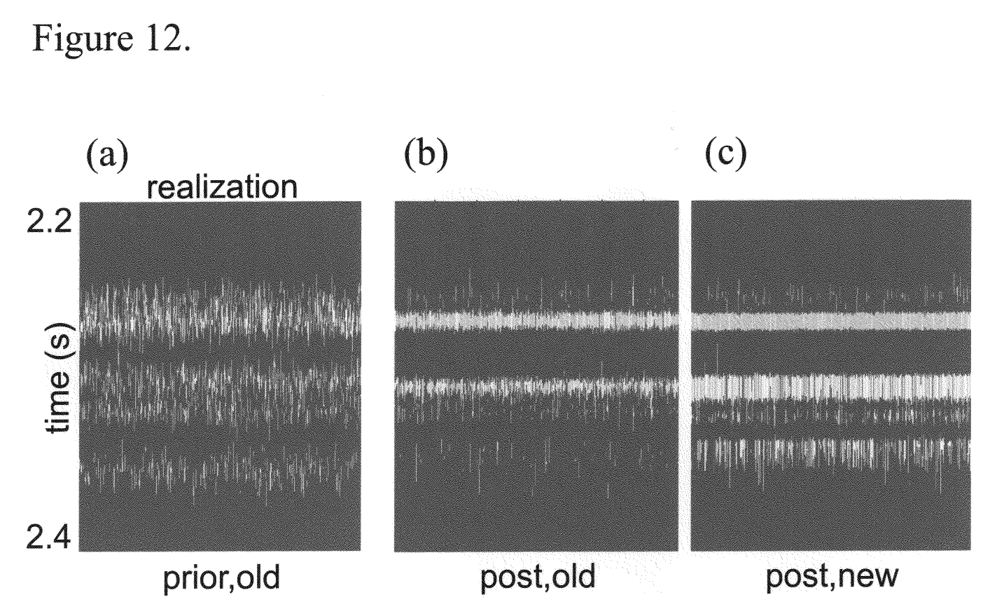

A very instructive perspective on the inversion results is obtained by examining all of the possible models that fit the data to within the SNR. FIGS. 12(a), 12(b) and 12(c) show the ensemble of N/G models for the three cases shown in FIGS. 11(a), 11(b) and 11(c), respectively. Notice the reduction in the uncertainty in the location of the top and base of the main and “a” sands with the new data. There is also less scatter in the N/G of both sands using the new data.

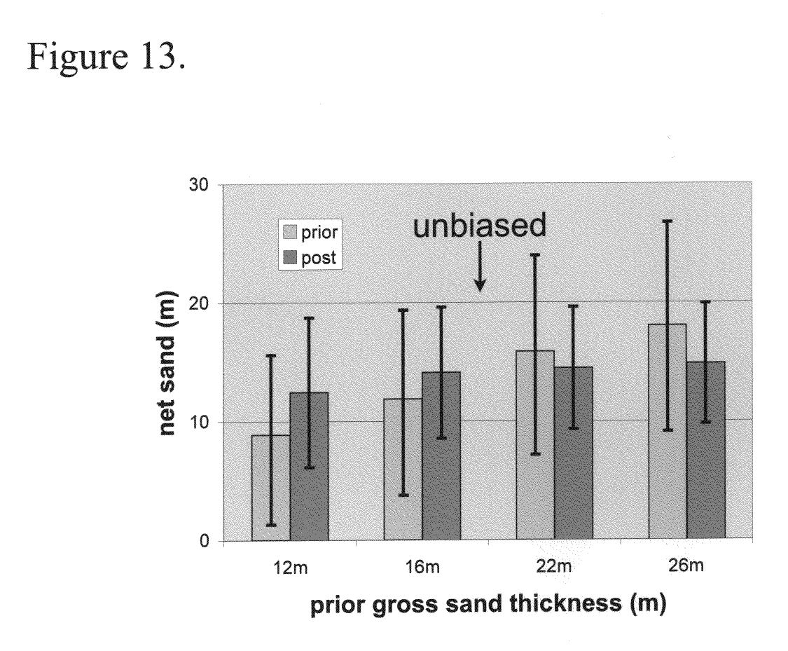

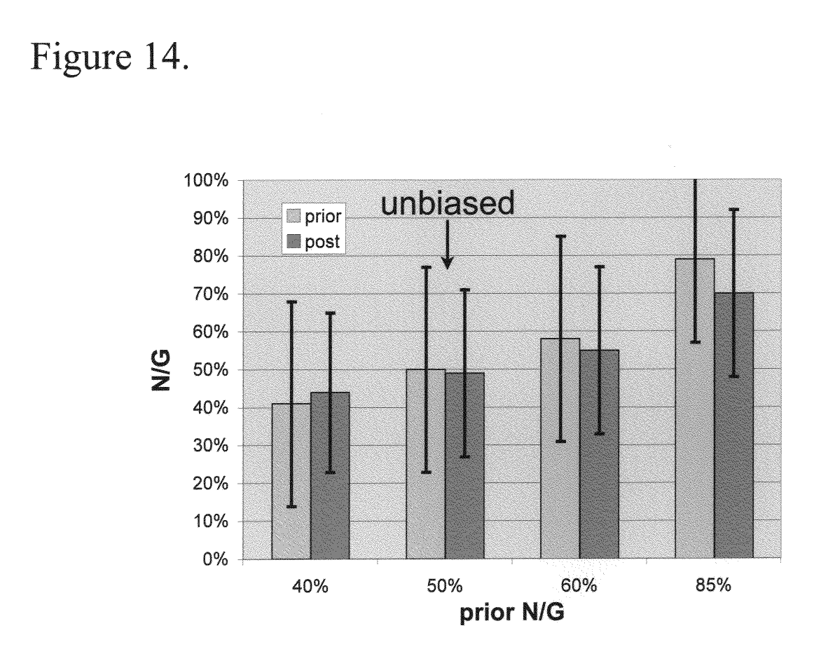

The existence of the fixed point and the convergence can be seen in FIGS. 13 and 14. They show the change in the net sand and N/G, respectively, for the “a sand” as the prior mean values are changed. The error bars represent the standard deviation. FIG. 13 shows the change in net sand as a function of the initial gross sand thickness, using an initial N/G of 85%, and FIG. 14 shows the change in N/G as a function of the initial N/G, using an initial gross thickness of 22 m The value indicated as unbiased in each case is the value of the prior gross sand thickness, and prior N/G, respectively, that results in no change of the posterior mean value when compared to the prior mean value. Note that for values less than this fixed point (labeled “unbiased”) the inversion increases the value. The greater the distance from the fixed point, the larger the change. The opposite is true for values greater than the fixed point—the inversion decreases the value.

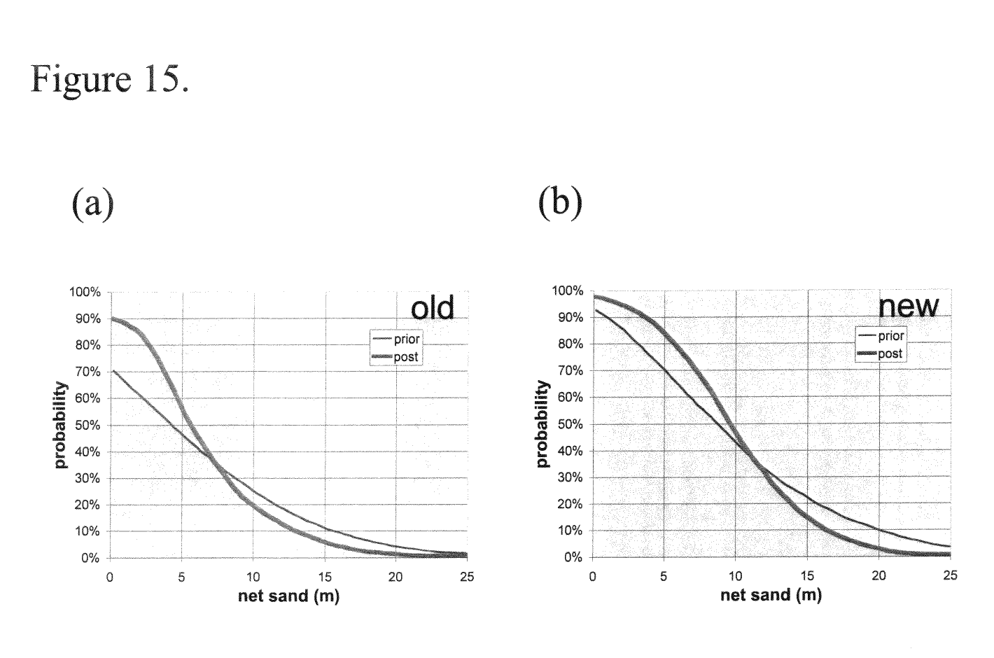

The bottom line results are shown in FIG. 15, where the cumulative probability distribution functions are shown for the net sand in the “a sand” using the old data (FIG. 15(a)) and the new data (FIG. 15(b)). Note that there is only a 65% probability of having at least 4 m of sand using the old data, and that probability is increased to 90% using the new data.

The described iterative inversion is an important and particularly advantageous refinement to Bayesian inversion when looking at marginal sands whose seismic reflection amplitude is near the noise level. For high noise levels, the data is whispering to you through the Bayesian inversion, but it is being overwhelmed by the heavy-handed sophomoric prior constraint imposed to eliminate unreasonable models. The iteration amplifies the whisper allowing convergence to the unbiased, predictive result free of the influence of the initial constraints. Increasing the bandwidth of the seismic data also is advantageous if these sands are poorly resolved.

### REFERENCES

“Bayesian Linearized AVO Inversion” by Arild Buland and Henning Omre (Geophysics, 68: 185-198, 2003), “Seismic reservoir prediction using Bayesian integration of rock physics and Markov random fields: A North Sea example” by Jo Eidsvik et al. (The Leading Edge 21: 290-294, 2002), “Stochastic reservoir characterization using prestack seismic data” by Jo Eidsvik et al. (Geophysics 69: 978-993, 2004), “Delivery: an open source model-based Bayesian seismic inversion program” by Gunning and Glinsky (Computers and Geosciences 30:619-636, 2004), “Stybarrow oil field—from seismic to production, the integrated story so far” by Ementon et al. (SPE Asia Pacific Oil and Gas Conference, Expanded Abstracts, #88574, 2004), “Integration of uncertain subsurface information into multiple reservoir simulation models” by Glinsky et al. (The Leading Edge 24:990-998, 2005), “Delivery-extractor: a new open source wavelet extraction and well tie program” by Gunning and Glinsky (Computers and Geosciences 32:681-695, 2006), “Inverse Problem Theory, Methods for Data Fitting and Model Parameter Estimation” by A. Tarantola, (Elsevier, Amsterdam, 1987), “Matrix computations” by Golub and Van Loan (John Hopkins University Press, Baltimore, 1996).

### APPENDIX

### Fixed Point Proof

In this section, the existence of a fixed point in the iterative inversion scheme is demonstrated. The algorithm has the property that the fixed point has an effectively “flat” prior in the iterated parameters. The convergence to the fixed point is linear. Important criteria for choice of the parameters to iterate are derived, in order to guarantee convergence.

We start with the linear approximation to the forward model valid near the optimum solution. The solution is given by (see Equations 36 and 37 from Gunning and Glinsky, 2004)

\tilde{m}=(\tilde{X}^{T}\tilde{X}+Cₘ⁻¹)⁻¹(\tilde{X}^{T}d+Cₘ⁻¹m₀) (1)

where d are the scaled seismic data residuals, \tilde{X} is the scaled linearization of the forward seismic model, Cₘ is the covariance matrix of prior probability distribution of the model, and m₀ is the prior estimate of the mean model. Suppose that for the next iteration we use

m₀←(Iₜ\tilde{m}+(I−Iₜ)m₀), (2)

where Iₜ is a matrix that selects a subvector to update (e.g., the time parameters). So in general

$$\begin{matrix}{\tilde{m}}_{k + 1} = {( {\tilde{X}}^{T} \tilde{X} + {C}_{m}^{- 1} )}^{- 1} ( {\tilde{X}}^{T} d + {C}_{m}^{- 1} ( {I}_{t} {\tilde{m}}_{k} + ( I - {I}_{t} ) {m}_{0} ) ) \\ = {( {\tilde{X}}^{T} \tilde{X} + {C}_{m}^{- 1} )}^{- 1} ( {\tilde{X}}^{T} d + {C}_{m}^{- 1} {I}_{t} {\tilde{m}}_{k} + {C}_{m}^{- 1} ( I - {I}_{t} ) {m}_{0} ) .\end{matrix} \qquad ( 3 )$$

The fixed point occurs at

\tilde{m}_{∞}=(I−\tilde{C}ₘ\tilde{C}ₘ⁻¹Iₜ)⁻¹\tilde{C}ₘ(\tilde{X}^{T}d+Cₘ⁻¹(I−Iₜ)m₀). (4)

and is stable if the eigenvalues, λ, of the matrix Qₚ defined by

Qₚ=\tilde{C}ₘCₘ⁻¹Iₜ=(\tilde{X}^{T}\tilde{X}+Cₘ⁻¹)⁻¹Cₘ⁻¹Iₜ=QIₜ (5)

satisfy |λ|<1. This is true if the submatrix of \tilde{X} corresponding to the “selected” subvector is full-rank.

Equation (4) can be simplified to

\tilde{m}_{∞}=(\tilde{X}^{T}\tilde{X}+Cₘ⁻¹(I−Iₜ))⁻¹(\tilde{X}^{T}d+Cₘ⁻¹(I−Iₜ)m₀) (6)

This is the standard Bayes formula with C_{m,new}⁻¹←Cₘ⁻¹(I−Iₜ), which is equivalent to using a new prior distribution with flat priors on the selected subvector. For example, if

$$\begin{matrix}{I}_{t} = ( \begin{matrix}I & 0 \\ 0 & 0\end{matrix} ) , \\ then & ( 7 ) \\ {C}_{m , new} = ( \begin{matrix}∞ I & 0 \\ 0 & {C}_{m , 22}\end{matrix} ) . & ( 8 )\end{matrix}$$

The iterative error term in Equation (3) is

Eₖ=Qₚ^{k}m₀ (9)

which satisfies Eₖ₊₁=O(Eₖ) with a fixed coefficient less than one that is dominated by the largest eigenvalue of Qₚ. The latter is less than one if the full-rank criterion \tilde{X} of the submatrix holds.

The conclusion is that successive iteration with replacements of a selected subvector converges to a fixed point equal to the single Bayes update with infinitely flat prior on the selected subvector. This convergence is guaranteed provided that at least one measurement responds to each subvector parameter, and sufficiently independently that full-rank of the sensitivity applies. The convergence is linear.

1. A method for determining improved estimates of properties of a model using a mathematical inversion, the method comprising the steps of:
(a) receiving estimated prior constraints for at least one model property,
(b) performing a first mathematical inversion on data for the model, using the estimated prior constraints, to produce an output posterior estimate of the at least one property,
(c) repeating the inversion at least once, using the output posterior estimate of any of the previous inversions to provide an input constraint for each successive inversion, to produce an improved posterior estimate of the at least one property.

2. A method as claimed in claim 1, wherein in step (a) the estimated prior constraints include a central value and associated range information for the property, and in step (c) the output central value of the previous inversion is used as the input central value for each successive inversion.

3. A method as claimed in claim 2, wherein the central value and range information comprise the mean and standard deviation.

4. A method as claimed in claim 2, wherein the central value comprises the median or the most likely value.

5. A method as claimed in claim 1, wherein the mathematical inversion is a Bayesian inversion.

6. A method as claimed in claim 2, wherein in step (c), each successive inversion uses as an input the estimated prior range information used for the first inversion.

7. A method as claimed in claim 1, wherein in step (c) the inversion is repeated no more than a predetermined number of times.

8. A method as claimed in claim 7, wherein in step (c) the inversion is repeated until it has been carried out the predetermined number of times.

9. A method as claimed in claim 2, wherein in step (c) the seismic inversion is repeated until the central value for the at least one property provided as an output of the most recent inversion differs from the input central value of said inversion by less than a predetermined amount.

10. A method as claimed in claim 9, wherein in step (c) the inversion is repeated until the output central value of the most recent inversion differs from the input central value of said inversion, for each property to be estimated, by less than a respective predetermined amount for each property.

11. A method as claimed in claim 1, wherein the mathematical inversion is a seismic inversion carried out on seismic data, and the model relates to properties of a subsurface region.

12. A method as claimed in claim 11, wherein the estimated prior constraints comprise Gaussian prior constraints on at least one of: seismic reflection times, gross thicknesses, and net-to-gross (N/G) values.

13. A method as claimed in claim 12, further comprising the step of using the improved posterior estimate of the at least one property to determine the viability of the subsurface region as a petroleum reservoir.

14. A method as claimed in claim 1, wherein in step (c) the output posterior estimate of the previous inversion is used to provide the input constraint for each successive inversion.

15. A computer program for implementing the method according to claim 1 on a computer.

16. A computer program product directly loadable into the internal memory of one or several digital computers, comprising software or hardware embedded code portions for performing the method steps of claim 1 when said product is run on a computer or several computers.

17. A computer readable medium on which is recorded a computer program, wherein the program when executed causes a computer or several computers to execute the method steps of claim 1.

18. A computer network comprising a plurality of computers interconnected via a communication medium and arranged to execute the method steps of claim 1.
